(19) United States
(12) Patent Application Publication
(10) Pub. No.: US 2010/0033434 A1
(43) Pub. Date: Feb. 11, 2010

(54) KEYBOARD

(75) Inventors: Shu Xie, Shenzhen City (CN); Yun-Shan Xiao, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Shenzhen City (TW)

(21) Appl. No.: 12/212,616

(22) Filed: Sep. 17, 2008

(30) Foreign Application Priority Data
Aug. 11, 2008 (CN) 200810303655.0

(51) Int. Cl. G06F 3/02

(52) U.S. Cl. 345/168

(57) ABSTRACT

A keyboard includes a main keypad, a numerical keypad, a switch, a keyboard control circuit, a calculator circuit, a display driver circuit, and a liquid crystal display screen. The keyboard control circuit is connected to the main keypad. The numerical keypad is connected to the keyboard control circuit and the calculator circuit selectively via the switch. The calculator circuit is further connected to the liquid crystal display screen via the display driver circuit. When the numerical keypad is connected to the calculator circuit via the switch, the numerical keypad is capable of processing a numerical calculation.

### BACKGROUND

1. Field of the Invention

The present disclosure relates to keyboards, and particularly to a keyboard with a numerical calculation function for a computer.

2. Description of the Related Art

A contemporary keyboard as an input device for a computer has very simple functions. The keyboard designers often focus their mind on improving keys of the keyboard rather than finding other uses for the keyboard. Often, people using a computer may like to perform numerical calculations. However, contemporary computers are not capable of processing numeral calculations via the keyboard directly. Therefore, it is necessary for people to get a calculator or open a program in the computer to perform calculations.

What is needed, therefore, is a keyboard for a computer which can overcome the above problems.

### BRIEF DESCRIPTION OF THE DRAWING

FIG. 1 is a configuration diagram of a keyboard in accordance with one embodiment of the present disclosure.

FIG. 2 is a block diagram of one embodiment of the keyboard of FIG. 1.

### DETAILED DESCRIPTION

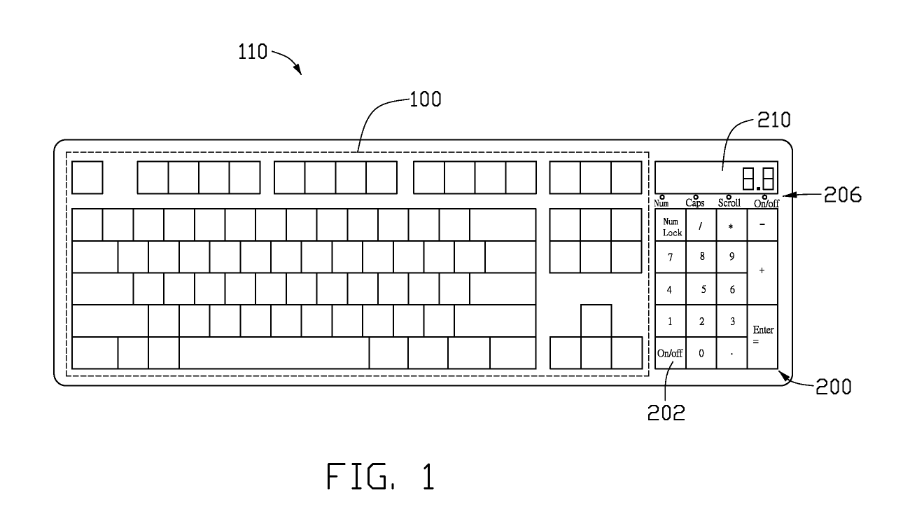

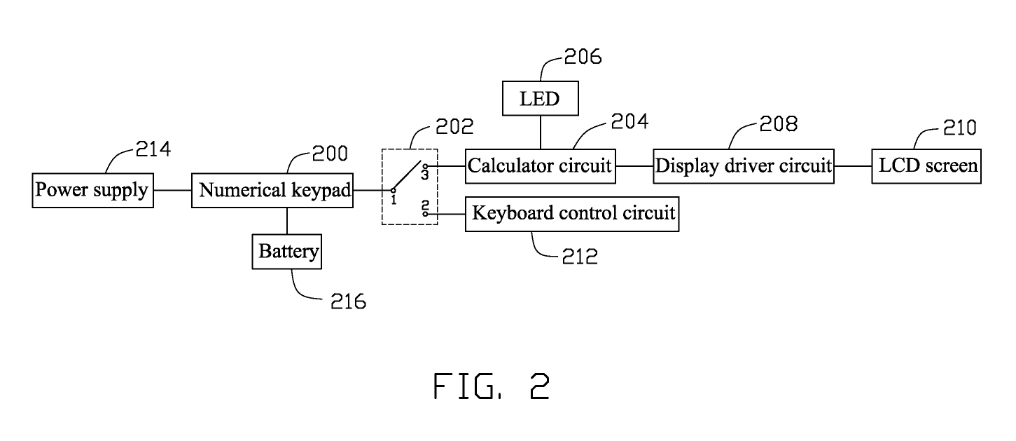

Referring to FIG. 1 and FIG. 2, one embodiment of a keyboard 110 of the present disclosure is shown. The keyboard 110 may be used in conjunction with a computer for inputting various numerical data to the computer. In one embodiment, the keyboard 110 includes a main keypad 100, a numerical keypad 200, a calculator circuit 204, four light-emitting diodes (LEDs) 206, a display driver circuit 208, a liquid crystal display (LCD) screen 210, and a keyboard control circuit 212. The configuration of keys of the main keypad 100 may be substantially the same as contemporary keyboards. In one embodiment, the numerical keypad 200 includes a “Num Lock” key, a “/” key, a “*” key, a “−” key, a “+” key, an “Enter” key, an “On/Off” key, a “.” Key, and ten numerical keys “0-9,” wherein the “On/Off” key is a switch 202 labeled in FIG. 2, and the functions of the other keys are the same as the contemporary keyboards. The LCD screen 210 is mounted adjacent the numerical keypad 200. The four LEDs 206, which are named respectively with “Num” LED, “Caps” LED, “Scroll” LED and “On/off” LED, are mounted between the numerical keypad 200 and the LCD screen 210. The functions of the “Num” LED, the “Caps” LED and the “Scroll” LED are the same as the contemporary keyboards. The “On/off” LED is used to indicate the status of the numerical keypad 200.

In one embodiment, the switch 202 is a push switch. A stationary contact 1 of the switch 202 is connected to the numerical keypad 200. A first movable contact 2 of the switch 202 is connected to the keyboard control circuit 212. A second movable contact 3 is connected to the calculator circuit 204. Therefore, the numerical keypad 200 is capable of working in two different modes selectable by use of the switch 202, a common input mode and a calculator input mode. The keyboard control circuit 212 is further connected to the main keypad 100 in order to process input information of the keyboard. The calculator circuit 204, which is employed to process the input of the numerical keypad 200 during calculator mode, is further connected to the LEDs 206 and the display driver circuit 208. The display driver circuit 208 is further connected to the LCD screen 210. The LCD screen 210 is employed to display the input and the result of operations performed on the input when the numerical keypad 200 is in the calculator input mode.

In one embodiment, power for the numerical keypad 200 may be provided by a power supply 214 or a battery 216 such that the numerical keypad 200 can still function as a calculator when the computer is off. In other embodiments, the switch 202, the LEDs 206, and the LCD screen 210 can be mounted at other places of the keyboard 110.

When the switch 202 is pushed to connect the stationary contact 1 to the second movable contact 3, the “On/off” LED is lit up, indicating that the numerical keypad 200 is in the calculator input mode. The numerical keypad 200 is capable of performing operations on the input to the numerical keypad 200 with results displayed by the LCD screen 210. When the switch 202 is pushed to connect the stationary contact 1 to the first movable contact 2, the “On/off” LED emits no light, indicating that the numerical keypad 200 is in the common input mode.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A keyboard, comprising:
a main keypad configured for processing an input information of the main keypad;
a keyboard control circuit connected to the main keypad;
a calculator circuit;
a switch;
a numerical keypad configured for being selectively connected to the keyboard control circuit or the calculator circuit via the switch, wherein the numerical keypad is further configured for processing an input information of the numerical keypad;
a display driver circuit, connected to the calculator circuit; and
a liquid crystal display screen, connected to the display driver circuit;
wherein the keyboard control circuit is capable of processing the input information of the main keypad and the input information of the numerical keypad upon the condition that the switch is set to connect the numerical keypad and the keyboard control circuit;
wherein the numerical keypad is capable of processing a numerical calculation upon the condition that the switch is set to connect the numerical keypad and the calculator circuit, wherein the liquid crystal display screen displays the input information of the numerical keypad and a result of the numerical calculation.

2. The keyboard as claimed in claim 1, wherein the keyboard further comprises a indication device connected to the calculator circuit.

3. The keyboard as claimed in claim 2, wherein the indication device is a lighting-emitting diode.

4. The keyboard as claimed in claim 1, wherein the keyboard further comprises a battery connected to the numerical keyboard.

5. The keyboard as claimed in claim 1, wherein the switch is a push switch mounted in the numerical keypad.

6. The keyboard as claimed in claim 1, wherein the switch comprise a stationary contact connected to the numerical keypad, a first movable contact connected to the keyboard control circuit, and a second movable contact connected to the calculator circuit.
